(19) United States
(12) Patent Application Publication
(10) Pub. No.: US 2025/0055544 A1
(43) Pub. Date: Feb. 13, 2025

(54) METHOD FOR CHANNEL STATE INFORMATION REPORT AND APPARATUS THEREOF

(71) Applicant: ZTE CORPORATION, Shenzhen (CN)

(72) Inventors: Xiaoying MA, Shenzhen (CN); Bo DAI, Shenzhen (CN); Jun XU, Shenzhen (CN); Mengzhu CHEN, Shenzhen (CN); Hong TANG, Shenzhen (CN); Qiujin GUO, Shenzhen (CN); Cheng GUO, Shenzhen (CN)

(73) Assignee: ZTE CORPORATION, Shenzhen (CN)

(21) Appl. No.: 18/933,654

(22) Filed: Oct. 31, 2024

Related U.S. Application Data
(63) Continuation of application No. PCT/CN2022/113983, filed on Aug. 22, 2022.

(51) Int. Cl. H04B 7/06; H04W 72/11; H04W 72/1268; H04W 72/231

(52) U.S. Cl. CPC H04B 7/0626; H04W 72/11; H04W 72/1268; H04W 72/231

(57) ABSTRACT

A wireless communication method for use in a wireless terminal is disclosed. The method comprises receiving, from a wireless network node, a high layer signaling including channel state information (CSI) report configuration information, receiving, from the wireless network node, a first signaling including a CSI report trigger state indication or a pattern indication, and reporting CSI according to the high layer signaling and the first signaling.

### CROSS-REFERENCE TO RELATED APPLICATION

This application claims the benefit of priority under 35 U.S.C. § 120 as a continuation of International Patent Application No. PCT/CN2022/113983, filed on Aug. 22, 2022, the disclosure of which is incorporated herein by reference in its entirety.

### TECHNICAL FIELD

This document is directed generally to wireless communications, in particular to fifth generation (5G) wireless communications, and in particular to channel state information (CSI) measurements and reports.

### BACKGROUND

With the development of wireless communication technology, the transmission rate, throughput, reliability, and other performance indexes of a wireless communication system have been greatly improved by using high frequency band, large bandwidth, multi-antenna and other technologies. Meanwhile, greenhouse gas emission caused by 5G base stations (e.g., gNB) and large power consumption have become an acute issue with the deployment of 5G technology. Therefore, network energy saving is important not only for a green communication system but also for reduction of the operation expense.

### SUMMARY

To reduce the power consumption of gNB, one potential method is reducing the number of antennas or antenna ports. The change in the number of antennas or antenna ports may have an impact on the CSI measurements or CSI reports. Therefore, a new method associated with the CSI measurements and/or the CSI reports for different number of antennas or antenna ports is needed. This document relates to methods, systems, and devices for wireless communications, and in particular for channel state information (CSI) measurements and reports.

The present disclosure relates to a wireless communication method for use in a wireless terminal. The method comprises:

receiving, from a wireless network node, a high layer signaling including channel state information, CSI, report configuration information,

receiving, from the wireless network node, a first signaling including a CSI report trigger state indication or a pattern indication, and

reporting CSI according to the high layer signaling and the first signaling.

Various embodiments may preferably implement the following features:

Preferably or in some embodiments, the CSI report configuration information comprises at least one of: a CSI report configuration, a CSI-RS resource configuration, or a trigger state list.

Preferably or in some embodiments, the trigger state list comprises trigger states associated with CSI report configurations and time domain behaviors of the plurality of CSI report configurations associated with the trigger state list comprise a plurality of time domain behaviors.

Preferably or in some embodiments, each trigger state in the trigger state list is associated with a plurality of CSI report configurations having the same or different time domain behaviors.

Preferably or in some embodiments, the time domain behavior associated with each trigger state comprise at least one of periodic, aperiodic, semi-persistent, semi-persistent on physical uplink control channel, PUCCH, or semi-persistent on physical uplink shared channel, PUSCH.

Preferably or in some embodiments, each trigger state in the trigger state list is associated with at least one periodic CSI report configuration.

Preferably or in some embodiments, the trigger state list comprises at least one subset trigger state list, wherein each subset trigger state list is associated with only a time domain behavior.

Preferably or in some embodiments, the at least one subset trigger state list comprises at least one of: an aperiodic trigger state list, a periodic trigger state list, a semi-persistent trigger state list, a semi-persistent on PUSCH trigger state list, or a semi-persistent on PUCCH trigger state list.

Preferably or in some embodiments, trigger states with the same index in the different subset trigger state lists are triggered when one of the trigger states is triggered.

Preferably or in some embodiments, each trigger state in the trigger state list is associated with at least one of: one or more CSI report configurations, one or more transmission configuration indicator, TCI, states, one or more CSI reference signal resource configurations, a time offset between a signaling triggering the trigger state and a slot configured for reporting the CSI based on a CSI report configuration corresponding to the trigger state, a delta of a power control offset, a power control offset, a power control offset synchronization signal, SS, a delta of a number of ports, used to determine a number of ports on which the CSI is determined based or a number of ports of a CSI reference signal, resource configuration, a repetition number, indicating a number of times of CSI reference signal resources being repeated in a time domain, or a number of ports.

Preferably or in some embodiments, the CSI report configuration is associated with a plurality of CSI resource configurations for channel measurements and/or a plurality of non-zero-power CSI reference signal resource configurations for interference measurements.

Preferably or in some embodiments, a periodic CSI report configuration in the CSI report configuration information is associated with at least one of an aperiodic CSI report configuration, a trigger state which is in an aperiodic trigger state list, a trigger state which is in a semi-persistent trigger state list, or a semi-persistent CSI report configuration.

Preferably or in some embodiments, a semi-persistent CSI report configuration in the CSI report configuration information is associated with an aperiodic CSI report configuration or a trigger state which is in an aperiodic trigger state list.

Preferably or in some embodiments, a periodic CSI report configuration or a semi-persistent CSI report configuration is triggered if at least one of the following event occurs: an aperiodic CSI report configuration associated with the periodic CSI report configuration or the semi-persistent CSI report configuration is triggered, a trigger state associated with the periodic CSI report configuration or the semi-persistent CSI report configuration is triggered, or a semi-persistent CSI report configuration associated with the periodic CSI report configuration or the semi-persistent CSI report configuration is triggered.

Preferably or in some embodiments, at least part of CSI reference signal resources included in a CSI resource configuration is valid if a CSI report configuration which is in the CSI report configuration information and is associated with the CSI resource configuration is triggered to be valid.

Preferably or in some embodiments, the valid CSI reference signal resources satisfy at least one condition.

Preferably or in some embodiments, the valid CSI reference signal resources satisfy a condition that a number of ports of the valid CSI resources included in the CSI resource configuration is less than or equal to a number of ports of the CSI report configuration associated with the CSI resource configuration.

Preferably or in some embodiments, the valid CSI reference signal resources satisfy a condition that the valid CSI reference signal resources is not configured with track reference signal information and/or repetition information.

Preferably or in some embodiments, the first signaling comprises at least one of downlink control information, DCI, or a media access control, MAC, control element, CE.

Preferably or in some embodiments, the DCI is group common DCI, broadcast DCI or multicast DCI.

Preferably or in some embodiments, the first signaling comprises at least one of: an activation indication associated with activating at least one CSI report configuration in the CSI report configuration information, a de-activation indication associated with deactivating at least one CSI report configuration in the CSI report configuration information, a field indicates whether to activate or deactivate the trigger state indicated in the first signaling, a serving cell identifier, indicating a serving cell for which the first signaling is applied, a bandwidth part identifier, indicating a downlink bandwidth part for which the first signaling is applied, a trigger state list identifier, indicating a list of trigger states which are activated or deactivated for reporting the CSI, a CSI report configuration identifier, indicating a CSI report configuration, a TCI state, a TCI state list, a trigger state indication, a first time offset between the first signaling and a slot in which the CSI is reported, a second time offset between the first signaling and a slot in which a CSI reference signal is received, a delta of a power control offset, a power control offset, a power control offset synchronization signal, SS, a delta of a number of ports, used to determine a number of ports on which the CSI is determined based or a number of ports of a CSI reference signal resource configuration, a repetition number, indicating a number of times of CSI reference signal resources being repeated in a time domain, a CSI report configuration identifier, a port number indication, a start new CSI calculation indication of regenerating the CSI based on the first signaling and the CSI report configuration information.

Preferably or in some embodiments, the DCI and the MAC CE are used to indicate different trigger states in the CSI report configuration information.

Preferably or in some embodiments, the CSI is measured or a CSI reference signal is received no earlier than a first delay after the first signaling is received.

Preferably or in some embodiments, the CSI is reported or a CSI reference signal is received no earlier than a second delay after the first signaling is received.

Preferably or in some embodiments, the CSI is reported no earlier than a third delay after the CSI is measured or a CSI reference signal is received.

Preferably or in some embodiments, the reporting the CSI according to the high layer signaling and the first signaling comprises:

triggering a CSI report configuration according to the high layer signaling and the first signaling, and

triggering a CSI reference signal resource configuration associated with the triggered CSI report configuration.

Preferably or in some embodiments, a TCI state of the CSI reference signal resource configuration is the same with a first TCI state applied for a control resource set used for physical downlink control channel within an active bandwidth part of a serving cell.

Preferably or in some embodiments, a TCI state of the CSI reference signal resource configuration is indicated by the first signaling.

Preferably or in some embodiments, a TCI state of the CSI reference signal resource configuration is associated with a trigger state.

Preferably or in some embodiments, a TCI state of the CSI reference signal resource configuration is the same with a TCI state of the first signaling.

Preferably or in some embodiments, a TCI state of the CSI reference signal resource configuration and a Synchronization Signal Block, SSB has a quasi-co-location relationship.

Preferably or in some embodiments, the wireless communication method further comprises transmitting, to the wireless network node, assistance information comprising at least one of a maximum number of ports, a preferred pattern or a fallback ask.

The present disclosure relates to a wireless communication method for use in a wireless network node. The method comprises:

transmitting, to a wireless terminal, a high layer signaling including channel state information, CSI, report configuration information,

transmitting, to the wireless terminal, a first signaling including a CSI report trigger state indication or a preferred pattern, and

receiving, from the wireless terminal, a CSI report.

Various embodiments may preferably implement the following features:

Preferably or in some embodiments, the CSI report configuration information comprises at least one of: a CSI report configuration, a CSI-RS resource configuration, or a trigger state list.

Preferably or in some embodiments, the trigger state list comprises trigger states associated with CSI report configurations and time domain behaviors of the CSI report configurations associated with the trigger state list comprise a plurality of time domain behaviors.

Preferably or in some embodiments, each trigger state in the trigger state list is associated with a plurality of CSI report configurations having the same or different time domain behaviors.

Preferably or in some embodiments, the time domain behavior associated with each trigger state comprise at least one of periodic, aperiodic, semi-persistent, semi-persistent on physical uplink control channel, PUCCH, or semi-persistent on physical uplink shared channel, PUSCH.

Preferably or in some embodiments, each trigger state in the trigger state list is associated with at least one periodic CSI report configuration.

Preferably or in some embodiments, the trigger state list comprises at least one subset trigger state list, wherein each subset trigger state list is associated with only a time domain behavior.

Preferably or in some embodiments, the at least one subset trigger state list comprises at least one of: an aperiodic trigger state list, a periodic trigger state list, a semi-persistent trigger state list, a semi-persistent on PUSCH trigger state list, or a semi-persistent on PUCCH trigger state list.

Preferably or in some embodiments, trigger states with the same index in the different subset trigger state lists are triggered when one of the trigger states is triggered.

Preferably or in some embodiments, each trigger state in the trigger state list is associated with at least one of: one or more CSI report configurations, one or more transmission configuration indicator, TCI, states, one or more CSI reference signal resource configurations, a time offset between a signaling triggering the trigger state and a slot configured for reporting the CSI based on a CSI report configuration corresponding to the trigger state, a delta of a power control offset, a power control offset, a power control offset synchronization signal, SS, a delta of a number of ports, used to determine a number of ports on which the CSI is determined based or a number of ports of a CSI reference signal, resource configuration, a repetition number, indicating a number of times of CSI reference signal resources being repeated in a time domain, or a number of ports.

Preferably or in some embodiments, the CSI report configuration is associated with a plurality of CSI resource configuration for channel measurements and/or a plurality of non-zero-power CSI reference signal resource configurations for interference measurements.

Preferably or in some embodiments, a periodic CSI report configuration in the CSI report configuration information is associated with at least one of an aperiodic CSI report configuration a trigger state which is in an aperiodic trigger state list, a trigger state which is in a semi-persistent trigger state list, or a semi-persistent CSI report configuration.

Preferably or in some embodiments, a semi-persistent CSI report configuration in the

CSI report configuration information is associated with an aperiodic CSI report configuration or a trigger state which is in an aperiodic trigger state list.

Preferably or in some embodiments, a periodic CSI report configuration or a semi-persistent CSI report configuration is triggered if at least one of the following events occurs: an aperiodic CSI report configuration associated with the periodic CSI report configuration or the semi-persistent CSI report configuration is triggered, a trigger state associated with the periodic CSI report configuration or the semi-persistent CSI report configuration is triggered, or a semi-persistent CSI report configuration associated with the periodic CSI report configuration or the semi-persistent CSI report configuration is triggered.

Preferably or in some embodiments, at least part of CSI reference signal resources included in a CSI resource configuration is valid if a CSI report configuration which is in the CSI report configuration information and is associated with the CSI resource configuration is triggered to be valid.

Preferably or in some embodiments, the valid CSI reference signal resources satisfy at least one condition.

Preferably or in some embodiments, the valid CSI reference signal resources satisfy a condition that a number of ports of the valid CSI resources included in the CSI resource configuration is less than or equal to a number of ports of the CSI report configuration associated with the CSI resource configuration.

Preferably or in some embodiments, the valid CSI reference signal resources satisfy a condition that the valid CSI reference signal resources is not configured with track reference signal information and/or repetition information.

Preferably or in some embodiments, the first signaling comprises at least one of downlink control information, DCI, or a media access control, MAC, control element, CE.

Preferably or in some embodiments, the DCI is group common DCI, broadcast DCI or multicast DCI.

Preferably or in some embodiments, the first signaling comprises at least one of: an activation indication associated with activating at least one CSI report configuration in the CSI report configuration information, a de-activation indication associated with deactivating at least one CSI report configuration in the CSI report configuration information, a field indicates whether to activate or deactivate the trigger state indicated in the first signaling, a serving cell identifier, indicating a serving cell for which the first signaling is applied, a bandwidth part identifier, indicating a downlink bandwidth part for which the first signaling is applied, a trigger state list identifier, indicating a list of trigger states which are activated or deactivated for reporting the CSI, a CSI report configuration identifier, indicating a CSI report configuration, a TCI state, a TCI state list, a trigger state indication, a TCI indication, a first time offset between the first signaling and a slot in which the CSI is reported, a second time offset between the first signaling and a slot in which a CSI reference signal is received, a delta of a power control offset, a power control offset, a power control offset synchronization signal, SS, a delta of a number of ports, used to determine a number of ports on which the CSI is determined based or a number of ports of a CSI reference signal resource configuration, a repetition number, indicating a number of times of CSI reference signal resources being repeated in a time domain, a CSI report configuration identifier, a port number indication, or a start new CSI calculation indication of regenerating the CSI based on the first signaling and the CSI report configuration information.

Preferably or in some embodiments, the DCI and the MAC CE are used to indicate different trigger states in the CSI report configuration information.

Preferably or in some embodiments, the wireless communication method further comprises receiving, from the wireless terminal, assistance information comprising at least one of a maximum number of ports a preferred pattern, or a fallback ask.

The present disclosure relates to a wireless terminal. The wireless terminal comprises:

a communication unit, configured to: receive, from a wireless network node, a high layer signaling including channel state information, CSI, report configuration information, and receive, from the wireless network node, a first signaling including a CSI report trigger state indication or a pattern indication, and

a processor configured to report CSI according to the high layer signaling and the first signaling.

Various embodiments may preferably implement the following feature:

Preferably or in some embodiments, the processor is further configured to perform any of aforementioned wireless communication methods.

The present disclosure relates to a wireless network node. The wireless network node comprises:

a communication unit, configured to:

transmit, to a wireless terminal, a high layer signaling including channel state information, CSI, report configuration information,

transmit, to the wireless terminal, a first signaling including a CSI report trigger state indication or a pattern indication, and

receive, from the wireless terminal, a CSI report.

Various embodiments may preferably implement the following feature:

Preferably or in some embodiments, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 shows a schematic diagram of a network according to an embodiment of the present disclosure.

FIG. 2 shows a schematic diagram of CSI-ReportConfig according to an embodiment of the present disclosure.

FIG. 3 shows a flowchart of a method according to an embodiment of the present disclosure.

FIGS. 4 to 10 show schematic diagrams of a trigger state list according to embodiments of the present disclosure.

FIG. 11 shows an example of a schematic diagram of a wireless terminal according to an embodiment of the present disclosure.

FIG. 12 shows an example of a schematic diagram of a wireless network node according to an embodiment of the present disclosure.

FIG. 13 shows a flowchart of a method according to an embodiment of the present disclosure.

FIG. 14 shows a flowchart of a method according to an embodiment of the present disclosure.

### DETAILED DESCRIPTION

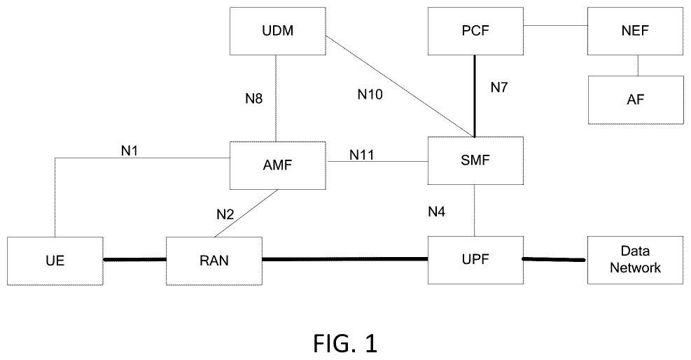

FIG. 1 shows a schematic diagram of a network (architecture) according to an embodiment of the present disclosure. In FIG. 1, the network comprises the following network functions/entities:

### 1) UE: User Equipment

### 2) RAN: Radio Access Network

In the present disclosure, the RAN may be equal to RAN node or next-generation RAN (NG-RAN) (node).

### 3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.

### 4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.

### 5) UPF: User Plane Function

The UPF includes the following functionalities: serving as an anchor point for intra-/inter-radio access technology (RAT) mobility and the external session point of interconnect to

Data Network, packet routing & forwarding as indicated by SMF, traffic usage reporting, quality of service (QOS) handling for the UP, downlink packet buffering and downlink data notification triggering, etc.

### 6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.

### 7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.

### 8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.

### 9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

In some embodiments, for the CSI measurements, the UE shall perform measurements based on CSI-RS (reference signal) and may report corresponding report (e.g., measurement results) to the gNB.

In an embodiment, a UE may be configured multiple CSI report configurations by a CSI-ReportConfig signaling. The CSI-ReportConfig is associated with one or more CSI-RS resource settings indicated by CSI-resourceConfigID. The CSI-RS resource setting is configured by a CSI-ResourceConfig signaling.

In an embodiment, a CSI-RS resource setting may include multiple CSI-RS resource sets. The CSI-RS resource set is configured by a NZP-CSI-RS-ResourceSet signaling.

In an embodiment, a CSI-RS resource set may include multiple CSI-RS resources. The CSI-RS resource is configured by a NZP-CSI-RS-Resource signaling.

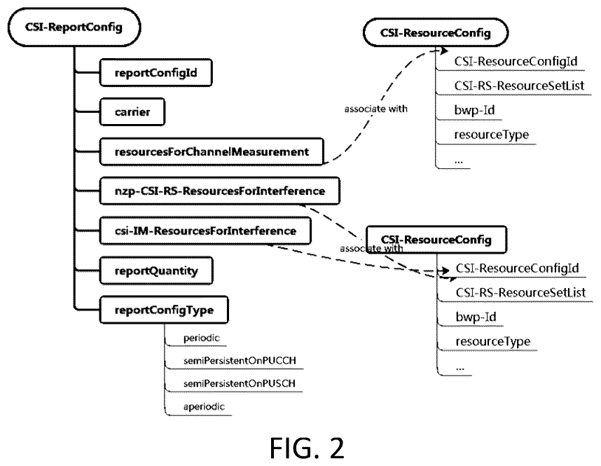

FIG. 2 shows a schematic diagram of CSI-ReportConfig according to an embodiment of the present disclosure.

In an embodiment, a reportConfigType is configured in a CSI report configuration. The reportConfigType indicates a time domain behavior of the CSI report configuration. The time domain behavior can be periodic, semiPersistentOnPUCCH, semiPersistentOnPUSCH, or aperiodic.

In an embodiment, a periodic CSI report configuration is valid after the periodic CSI report configuration is configured by an RRC (radio resource control) signaling.

In an embodiment, a semi-persistentOnPuCCH CSI report configuration is valid if the UE receives a MAC CE (media access control control element) signaling which activates the semi-persistentOnPuCCH CSI report configuration.

In an embodiment, a semi-persistentOnPUSCH CSI report configuration is valid if the UE receives a DCI indicates a trigger state which is associated with the semi-persistentOnPUSCH CSI report configuration.

In an embodiment, an aperiodic CSI report configuration is triggered when the UE receives DCI indicates a trigger state which is associated with the aperiodic CSI report configuration.

In an embodiment, an RRC signaling semiPersistentOnPUSCH-TriggerStateList or CSI-SemiPersistentOnPUSCH-TriggerStateList is configured. In this signaling, a list of CSI report configurations configured with semi-persistentOnPUSCH is included. The DCI may be used to indicate one semi-persistentOnPUSCH CSI report configuration of them.

In an embodiment, an RRC signaling aperiodicTriggerStateList or CSI-Aperiodic TriggerStateList In this is configured. signaling, a list of associatedReportConfigInfoList is included, each associatedReportConfigInfoList includes a list of CSI-AssociatedReportConfigInfo which is associated with an aperiodic CSI report configuration. The DCI can be used to indicate one of the associatedReportConfigInfoList. That is, the DCI can indicate a list of aperiodic CSI report configurations.

The number of ports of a CSI-RS (CSI-RS port, hereinafter) is configured by nrofPorts in CSI-ResourceMapping, The CSI-ResourceMapping is associated with a NZP-CSI-RS-Resource. The nrofPorts can be one of the following: p1, p2, p4, p8, p12, p16, p24, p32 (e.g., integers 1, 2, 4, 8, 12, 16, 24 and 32). That is p1 represents that the number of ports of the CSI-RS is 1, p2 represents that the number of ports of the CSI-RS is 2, and so on.

If the number of base station antennas changes, the channel may change, and the number of CSI-RS ports may also need to change. For example, the base station with 4 antennas can support 4 ports CSI-RS. If the number of antennas is decreased to 2, the base station cannot support the 4 ports CSI-RS. In an embodiment, it would be helpful if the UE can provide channel measurements for different antenna port numbers. However, most of CSI-RS resource settings and CSI report configurations are configured by the RRC signaling. Furthermore, only an aperiodic

CSI report configuration can be triggered by a DCI. That is the BS cannot change the CSI report configuration quickly based on the change in the number of BS antennas. In the present disclosure, a dynamic method for changing the CSI report configuration is provided.

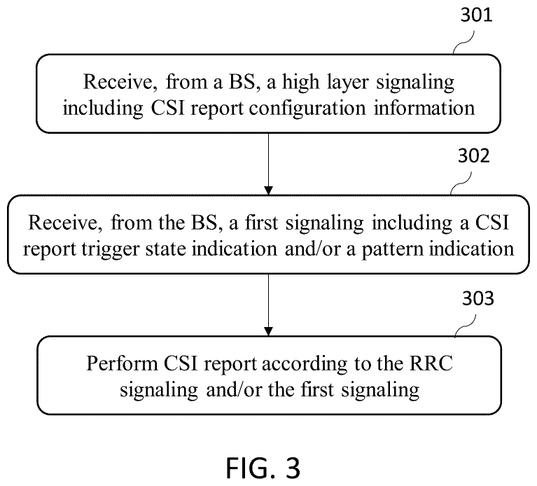

FIG. 3 shows a flowchart of a method according to an embodiment of the present disclosure. The method shown in FIG. 3 may be used in the UE and comprises the following steps:

Step 301: Receive, from a BS, a high layer signaling including CSI report configuration information.

Step 302: Receive, from the BS, a first signaling including a CSI report trigger state indication and/or a pattern indication.

Step 303: Perform CSI report according to the RRC signaling and/or the first signaling.

Specifically, the UE may receive a high layer signaling including CSI report configuration information. The high layer signaling may be a MAC CE signaling or an RRC signaling. In some embodiments, the high layer signaling includes at least one of: a CSI report configuration, a CSI-RS resource configuration, or a trigger state list.

In some embodiments, the CSI-RS resource configuration may include at least one of: a CSI-ResourceConfig, a NZP (Non-zero-power) CSI-RS (CSI reference signal) ResourceSet, a NZP CSI-RS Resource, a CSI-RS resourceMapping, a ZP-CSI-RS-ResourceSet, or a ZP-CSI-RS-Resource.

In some embodiments, the trigger state list includes one or more trigger states. Each trigger state may be associated with one or more CSI report configurations. The trigger state(s) in the trigger state list may be associated with one or more CSI report configurations configured with different time domain behaviors (e.g., the time domain behavior configured in reportConfigType signaling). For example, the time domain behaviors include periodic, semi-persistent, semiPersistentOnPUCCH, semiPersistentOnPUSCH, or aperiodic.

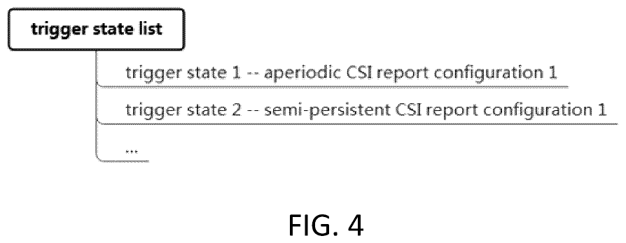

FIG. 4 shows a schematic diagram of a trigger state list according to an embodiment of the present disclosure. In FIG. 4, the trigger state list comprises a trigger state 1 associated with an aperiodic CSI report configuration 1 and a trigger state 2 associated with a semi-persistent CSI report configuration 1.

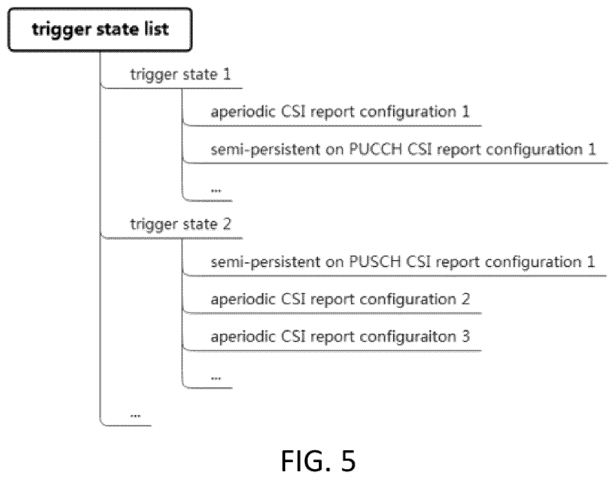

FIG. 5 shows a schematic diagram of a trigger state list according to an embodiment of the present disclosure. The trigger state list shown in FIG. 5 comprises a trigger state 1 and a trigger state 2. In this embodiment, the trigger state 1 is associated with an aperiodic CSI report configuration 1 and a semi-persistent on PUCCH CSI report configuration 1 and the trigger state 2 is associated with a semi-persistent on PUSCH CSI report configuration 1, an aperiodic CSI report configuration 2 and an aperiodic CSI report configuration 3.

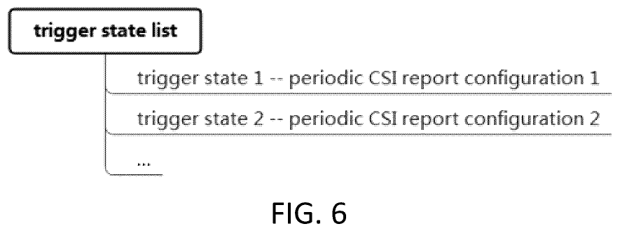

In some embodiments, a trigger state list includes one or more trigger states and each trigger state may be associated with one or more periodic CSI report configurations. For example, a trigger state list shown in FIG. 6 comprises a trigger state 1 associated with a periodic CSI report configuration 1 and a trigger state 2 associated with a periodic CSI report configuration 2.

In an embodiment of the trigger state list includes one or more trigger states and each trigger state is associated with one or more periodic CSI report configurations, the periodic CSI report configuration is triggered being active/valid and the other periodic CSI report configurations which are associated with untriggered trigger state are not triggered are de-active/invalid.

In an embodiment of the trigger state list includes one or more trigger states and each trigger state is associated with one or more periodic CSI report configurations, whether or not the periodic CSI report configuration configured in the trigger state list is valid and/or triggered and/or active is determined based on the first signaling. One periodic CSI report configuration not included in the trigger state list is valid when this periodic CSI report configuration is configured in a csi-ReportConfigToAddModList. In other words, the periodic CSI report configurations which are not included in the trigger state list are not controlled by the first signaling. In some embodiments, the status (e.g., active or de-active) of others CSI report configuration which are in the trigger state list but not indicated by the first signaling does not change.

In some embodiments, the trigger state list includes one or more subset trigger state lists. In one embodiment, the subset trigger state lists include at least one of:
an aperiodic trigger state list,
a periodic trigger state list,
a semi-persistent trigger state list,
a semi-persistent on PUSCH trigger state list, or
a semi-persistent on PUCCH trigger state list.

Note that each subset trigger state list may be associated only with the CSI report configurations having the same kind of time domain behavior (e.g., periodic, aperiodic, semi-persistent, . . . , etc.).

In an embodiment, triggering a trigger state X means triggering the trigger state X in each subset trigger, where X is an index. In an embodiment, triggering a trigger state X means triggering the X-th trigger state in each subset trigger state list. In an embodiment of the X-th trigger state is triggered, if one subset trigger state list does not include trigger state X, the trigger state in the subset trigger state list will not be triggered.

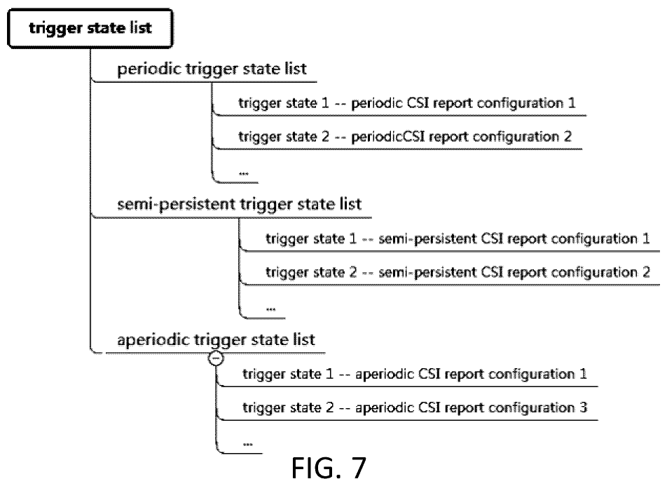

FIG. 7 shows a schematic diagram of a trigger state list according to an embodiment of the present disclosure. The trigger state list comprises the periodic trigger state list, the semi-persistent trigger state list and an aperiodic trigger stat list. The periodic trigger state list comprises a trigger state 1 associated with a periodic CSI report configuration 1, a trigger state 2 associated with a periodic CSI report configuration 2, . . . , etc. The semi-persistent trigger state list comprises a trigger state 1 associated with a semi-persistent CSI report configuration 1, a trigger state 2 associated with a semi-persistent CSI report configuration 2, . . . , etc. The aperiodic trigger state list comprises a trigger state 1 associated with an aperiodic CSI report configuration 1, a trigger state 2 associated with an aperiodic CSI report configuration 2, . . . , etc.

In some embodiments, a trigger state list includes two kinds of trigger state list, wherein one kind of trigger state list includes at least one of: report on PUCCH CSI trigger state or report on PUSCH CSI trigger state.

In an embodiment, the report on PUCCH CSI trigger state is associated with a periodic CSI report configuration and/or a semi-persistentOnPUCCH CSI report configuration.

In an embodiment, the Report on PUSCH CSI trigger state is associated with a semi-persistentOnPUSCH CSI report configuration and/or an aperiodic CSI report configuration. In an embodiment, a time offset is triggered when a report on PUSCH CSI trigger state is triggered.

In some embodiments, a periodic or semi-persistentOnPUCCH CSI report configuration may configured with one or more PUCCH resources (e.g., PUCCH-CSI-Resources). The PUCCH resource is the resource on which a CSI report can be transmitted. In an embodiment, the PUCCH resources of a periodic or semi-persistentOnPUCCH CSI report configuration in a same trigger state are the same. As an alternative or in addition, the PUCCH resources of a periodic or semi-persistentOnPUCCH CSI report configuration in different trigger states is the same.

In some embodiments, each trigger state may be associated with one or more CSI report configurations configured with a codebook configuration (e.g., CodebookConfig). In an embodiment, the number of antenna ports (e.g., nrOfAntennaPorts) of CSI report configuration which are associated with one same trigger states are same. In some embodiments, the number of antenna ports (e.g., nrOfAntennaPorts) configured with a CSI report configuration which are associate with different trigger states are different.

In some embodiments, each trigger state may be associated with at least one of: one or more CSI report configurations, one or more TCI (Transmission Configuration Indicator) states, one or more CSI-RS resource configuration, a first time offset, a first time offset index, a second time offset, a second time offset index, a delta of a power control offset, a power control offset, a power control offset SS (synchronization signal), a delta of a port number, a repetition number, a port number.

In an embodiment, the TCI state is used for a first kind time domain behavior CSI-RS resource configuration which is associated with the triggered CSI report configuration. The first kind time domain behavior includes at least one of: semi-persistent or aperiodic. In another embodiments, the first kind time domain behavior includes at least one of: periodic, semi-persistent or aperiodic. Semi-persistent includes semi-persistentOnPUCCH and/or semi-persistentOnPUSCH.

In an embodiment, the TCI state is used for a first kind usage CSI-RS resource configuration which is associated with the triggered CSI report configuration. For example, the first kind usage includes at least one of a channel measurement and an intra-cell interference measurement.

In an embodiment, a trigger state is associated with one TCI state. In an embodiment, the TCI state is used for all CSI report configurations associated with the trigger state which associates with a first kind usage of CSI-RS resource configuration and/or associates with a first kind time domain behavior.

In an embodiment, the TCI state is used for all the CSI-RS resource configuration associated with the trigger state.

In an embodiment, the TCI state is used for the semi-Persistent CSI-RS resource configuration associated with the CSI report configurations which are triggered.

In an embodiment, the TCI state is used for semi-Persistent CSI-RS resource configuration and aperiodic CSI-RS resource configuration associated with the CSI report configurations which are triggered.

In an embodiment, the TCI state is used for semi-Persistent CSI-RS resource configuration and periodic CSI-RS resource configuration associated with the CSI report configurations which are triggered.

In an embodiment, the first time offset indicates an offset between a signaling which triggers a trigger state and a slot where the UE can report the CSI according to the CSI report configuration associated with the triggered trigger state. In an embodiment, the first time offset indicates an offset between two CSI reports. If the first time offset is configured in a trigger state list, the first time offset or a first time offset list (i.e. a list of first time offsets) which is configured in a CSI report configuration associated with the trigger stat list can be ignored. In an embodiment, a trigger state is associated with a first time offset.

In an embodiment, the first time offset index indicates a first time offset in a first time offset list which is configured in a CSI report configuration.

In an embodiment, a first time offset (value) configured for the CSI report configuration in the trigger state list is smaller than a threshold. For instance, the threshold is an integer value greater than 0 and less than 8.

In an embodiment, the second time offset indicates an offset between a signaling which triggers a trigger state and a slot where the UE receives CSI-RS. In an embodiment, the second time offset is indicated by indicating a second time offset index in a second time offset list (i.e., a list of second time offsets) which is configured in a CSI-RS resource configuration.

In an embodiment, the delta of power control offset (P_delta) indicates a change in power control offset. The power control offset (P) UE used for CSI report is determined by the power control offset configured in an associated CSI-RS resource configuration (P_1) and the delta of power control offset (P_delta). For example, P=P_1−P_delta. power control offset can be PowerControlOffset or PowerControlOffsetSS configured in NZP-CSI-RS-Resource signaling.

In an embodiment, the power control offset refers to powerControlOffset which is an assumed ratio of PDSCH EPRE (energy per resource element) to NZP (non-zero power) CSI-RS EPRE when the UE derives the CSI feedback/report.

In an embodiment, the power control offset SS refers to powerControlOffsetSS which is an assumed ratio of the NZP CSI-RS EPRE to SSB (SS/PBCH block) EPRE.

In an embodiment, the delta of the port number is used to determine a port number UE assumed to calculate the CSI or the number of ports of the CSI-RS resource configuration. For example, the UE is triggered for a CSI report by an indicated trigger state, the port number configured for a CSI-RS resource which is associated with the CSI report is PN_1 and the delta of the port number is PN_2. Under such conditions, the port number UE used to calculate the CSI is PN=PN_1−PN_2 or PN=PN_1+PN_2. As an alternative, the delta of the port number is a scaling factor PN_3 for the port number PN_1. For example, PN=PN_1/PN_3 or PN=PN_1*PN_3. The time and/or frequency resource for the port number PN is derived according to the time and/or frequency resource which is configured. For another example, the UE is triggered for a CSI report by an indicated trigger state, the port number configured for the CSI report configuration is PN_1 and the delta of the port number is PN_2. Under such conditions, the port number PN used by the UE for calculating or reporting the CSI or PMI (Pre-coding Matrix Indicator) is PN =PN_1−PN_2 or PN=PN_1+PN_2. Or the delta of the port number is a scaling factor PN_3 for the port number PN_1 (e.g., PN=PN_1/PN_3, PN=PN_1*PN_3).

In an embodiment, the repetition number indicates the CSI-RS repetition number in the time domain. For instance, the CSI-RS repeats multiple times in time domain and the repeating times of the CSI-RS is indicated by the repetition number included in the CSI report configuration information. The first version of CSI-RS is configured by the RRC signaling, the next repeat version starts at a slot which is the X-th slot after the end of the prior CSI-RS resource, wherein X is an integer (e.g., X=1).

In some embodiments, a CSI report configuration may be associated with more than one high layer signaling resourcesForChannelMeasurement or more than one high layer signaling nzp-CSI-RS-ResourcesForinterference. In some embodiments, a CSI report configuration may be associated with more than one CSI-RS resource setting which is for channel measurements. In some embodiments, a CSI report configuration may be associated with more than one CSI-RS resource setting which is for interference measurements.

In some embodiments, a trigger state list includes multiple trigger states. Each trigger state is associated with one or more CSI report configurations.

In an embodiment of the trigger state list includes multiple trigger states and each trigger state is associated with one or more CSI report configurations, the port number of a CSI-RS resource configuration which is associated with a CSI report configuration within one trigger state are the same.

In an embodiment of the trigger state list includes multiple trigger states and each trigger state is associated with one or more CSI report configurations, a time and/or frequency resource of a CSI-RS resource configuration which is associated with a CSI report configuration within a first trigger state is a subset of the time and/or frequency resource of CSI-RS resource configuration which is associated with a CSI report configuration within a second trigger state.

In an embodiment of the trigger state list includes multiple trigger states and each trigger state is associated with one or more CSI report configurations, the powerControlOffset/powerControlOffsetSS of a CSI-RS resource configuration which is associated with a CSI report configuration within a first trigger state is less than the powerControlOffset/powerControlOffsetSS of a CSI-RS resource configuration which is associated with a CSI report configuration within a second trigger state. In this embodiment, the port number of the CSI-RS resource configuration which associated with the CSI report configuration within the second trigger state may be larger than the port number of the CSI-RS resource configuration which is associated with the CSI report configuration within the first trigger state.

In some embodiments, the CSI report configuration in the trigger state list is specific designed.

For example, the specific design for the CSI report configuration in the trigger state list may be based on at least one of the following embodiments of parameters/elements in the CSI report configuration in the trigger state list.

In an embodiment, a trigger offset list in a CSI report configuration may be configured with only one trigger offset.

In an embodiment, a report offset list in a CSI report configuration which is associate with a trigger state can only be configured with one report offset value.

In an embodiment, a first kind report type of a CSI report configuration may be configured. For instance, the first kind report type includes at least one of: cri-RI-il, cri-RI-il-CQI, cri-Ri-CSI, cri-RSRP; The report type includes: none, cri-RI-il, cri-RI-il-CQI, cri-Ri-CSI, cri-RSRP, cri-RI-PMI-CQI, ssb-Index-RSRP, cri-RI-LI-PMI-CQI.

In an embodiment, a higher layer parameter timeRestrictionForChannelMeasurements signaling in the CSI report configuration is configured as ‘configured’. Note that if the higher layer parameter timeRestrictionForChannelMeasurements in CSI-ReportConfig is set to “Configured”, the UE shall derive the channel measurements for computing CSI reported in uplink slot n based on only the most recent, no later than the CSI reference resource, occasion of NZP CSI-RS associated with the CSI resource setting.

In an embodiment, the CSI-RS resource associated with the CSI report configuration is specifically designed. For example, the CSI-RS resource may be specifically designed as at least one of the following:
the CSI-RS resource configuration is associated with a first kind time domain behavior: In an embodiment, the first kind time domain behavior includes at least aperiodic;
the aperiodicTriggeringOffset configured in a CSI-RS resource configuration which is associate with a trigger state or which is associated with a CSI report configuration in a trigger state is configured with only one aperiodic trigger offset value. Note that the aperiodic trigger offset value indicates a time offset between DCI and a CSI-RS resource.

In some embodiments, the CSI report configurations in the trigger state list are not valid before they are triggered. For example, the CSI report configuration in the trigger state list may be activated/valid only when receiving (the first signaling indicating/including) a trigger state which triggers/is associated with the CSI report configuration.

In an embodiment, the periodic CSI report configuration may be valid/active once it is configured.

In an embodiment, the semi-persistent On PUCCH CSI report configuration is valid/active when the UE receive an activation MAC CE for the semi-persistent On PUCCH CSI report configuration.

In an embodiment, the semi-persistent On PUSCH report configuration or the aperiodic CSI report configuration is valid/active when the UE receives DCI triggering a trigger state which trigger the report configuration. In an embodiment, the trigger state list can be used to de-activate a trigger state.

In some embodiments, a periodic CSI report configuration may (be configured to) be associated with an aperiodic CSI report configuration or a semi-persistent CSI report configuration. If the aperiodic CSI report configuration or the semi-persistent CSI report configuration is triggered, the associated periodic CSI report configuration is also triggered.

In some embodiments, a periodic CSI report configuration may (be configured to) be associated with a trigger state in a trigger state list. If the trigger state is triggered, the associated periodic CSI report configuration is also triggered. The trigger state list may be configured by a semiPersistentOnPUSCH-TriggerStateList, a CSI-SemiPersistentOnPUSCH-TriggerStateList, an aperiodicTriggerStateList, a CSI-AperiodicTriggerStateList, an associatedReportConfigInfoList, or a CSI-AssociatedReportConfigInfo.

In some embodiments, a semi-persistent CSI report configuration may (be configured to) be associated with a trigger state in a trigger state list. If the trigger state is triggered, the associated periodic CSI report configuration is also triggered. The trigger state list may be configured by an aperiodicTriggerStateList, a CSI-AperiodicTriggerStateList, an associatedReportConfigInfoList, or a CSI-AssociatedReportConfigInfo.

In some embodiments, a trigger state in a first trigger stage list is configured to be associated with a trigger state in a second trigger state list. The second trigger state list may be an aperiodic TriggerStateList, a CSI-AperiodicTriggerStateList, an associatedReportConfigInfoList, asemiPersistentOnPUSCH-TriggerStateList, or a CSI-SemiPersistentOnPUSCH-TriggerStateList. If a trigger state in the second trigger state list is triggered, the associated trigger state in the first trigger state list is also triggered.

In some embodiments, a semi-persistent CSI report configuration may (be configured to) be associated with an aperiodic CSI report configuration. If the aperiodic CSI report configuration is triggered, the associated semi-persistent CSI report configuration is also triggered.

In some embodiments, a trigger state in the trigger state list is configured to be associates with an aperiodic CSI report configuration or a semi-persistent CSI report configuration. If the aperiodic CSI report configuration or the semi-persistent CSI report configuration is triggered, the CSI report configuration(s) in the associated trigger state is also triggered.

In some embodiments, if a CSI report configuration in the trigger state is triggered to be valid, the CSI-RS resource (configuration) associated with the CSI report configuration is also valid.

In some embodiments, if a CSI report configuration in the trigger state is triggered to be valid, a part of or all of the CSI-RS resources in the CSI-RS resource configuration associated with the triggered CSI report configuration are also valid.

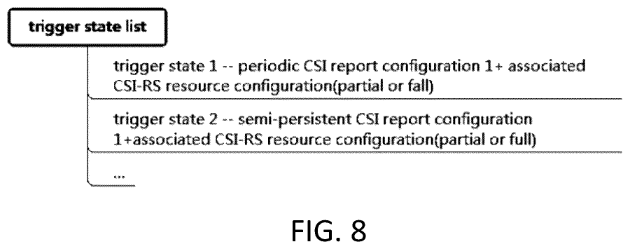

FIG. 8 shows a schematic diagram of the trigger state list according to an embodiment of the present disclosure. In FIG. 8, the trigger state list comprises a trigger state 1 is associated with a periodic CSI report configuration 1 and a trigger state 2 associated with a semi-persistent CSI report configuration 1. When the periodic CSI report configuration 1 is triggered to the valid (or the trigger state 1 is indicated/triggered by the first signaling), a part of or all of CSI-RS resources in the CSI-RS resource configuration associated with the periodic CSI report configuration 1 is also valid/triggered. Similarly, when the semi-persistent CSI report configuration 1 is triggered (or the trigger state 2 is triggered/indicated by the first signaling) to be valid, a part of or all of CSI-RS resources in the CSI-RS resource configuration associated with the semi-persistent CSI report configuration 1 is also valid.

In an embodiment, a CSI-RS resource configuration includes one or more CSI-RS resource sets and one CSI-RS resource set includes one or more CSI-RS resources.

In an embodiment, the part of CSI-RS resources in the CSI-RS resource configuration which is valid when the associated CSI report configuration is triggered is a first kind of CSI-RS resources in the CSI-RS resource configuration. For example, the first kind of CSI-RS resources comprises the CSI-RS resources configured with a port number less than or equal to the port number associated with the trigger state. As an alternative or in addition, the first kind of CSI-RS resources comprises the CSI-RS resources which are not configured with trs-info (track reference signal information) and/or repetition (information).

In some embodiments, the first signaling includes at least one of the following information: an activation/de-activation indication, a trigger state indication, a TCI indication, a first time offset, a first time offset index, a delta of a power control offset, a power control offset indication, a pattern indication, a delta of a port number, a repetition number, a CSI report configuration ID (identifier), a port number indication, a second time offset, a second time offset index, a start new CSI calculation indication. In some embodiments, the information included in the first signaling is a CSI report trigger state indication.

In an embodiment, the first time offset is an offset between the first signaling and a slot of PUSCH in which the UE reports the CSI. In some embodiments, the first time offset is an offset between two CSI reports.

In an embodiment, the power control offset can be a power control offset or a power control offset SS. In an embodiment, the power control offset indication indicates the power control offset to replace the original power control offset for the CSI-RS resource which is associated with the triggered CSI report configuration.

In an embodiment, the pattern indication indicates a valid pattern in a table. For example, the table may be:

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + | 0, 0, 0 | 0 | 0 |
| | | | | 4, l₀), (k₀ + 8, l₀) | | | |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), | 0, 1, 2, 3 | 0, 1 | 0 |
| | | | | (k₂, l₀), (k₃, l₀) | | | |
| 7 | 8 | 1 | fd-CDM2 | (k₀, l₀), | 0, 1, 2, 3 | 0, 1 | 0 |
| | | | | (k₁, l₀), (k₀, l₀ + 1), | | | |
| | | | | (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), | 0, 1, 2, 3, 4, 5 | 0, 1 | 0 |
| | | | | (k₂, l₀), | | | |
| | | | | (k₃, l₀), (k₄, l₀), | | | |
| | | | | (k₅, l₀) | | | |
| 10 | 12 | 1 | cdm4-FD2- | (k₀, l₀), (k₁, l₀), | 0, 1, 2 | 0, 1 | 0, 1 |
| | | | TD2 | (k₂, l₀) | | | |
| 11 | 16 | 1, 0.5 | fd-CDM2 | (k₀, l₀), (k₁, l₀), | 0, 1, 2, 3, | 0, 1 | 0 |
| | | | | (k₂, l₀), | 4, 5, 6, 7 | | |
| | | | | (k₃, l₀), (k₀, l₀ + 1), | | | |
| | | | | (k₁, l₀ + 1), | | | |
| | | | | (k₂, l₀ + 1), | | | |
| | | | | (k₃, l₀ + 1) | | | |
| 12 | 16 | 1, 0.5 | cdm4-FD2- | (k₀, l₀), (k₁, l₀), | 0, 1, 2, 3 | 0, 1 | 0, 1 |
| | | | TD2 | (k₂, l₀), (k₃, l₀) | | | |
| 13 | 24 | 1, 0.5 | fd-CDM2 | (k₀, l₀), (k₁, l₀), | 0, 1, 2, 3, 4, 5, | 0, 1 | 0 |
| | | | | (k₂, l₀), (k₀, l₀ + | 6, 7, 8, 9, 10, 11 | | |
| | | | | 1), (k₁, l₀ + 1), | | | |
| | | | | (k₂, l₀ + 1), (k₀, l₁), | | | |
| | | | | (k₁, l₁), (k₂, l₁), | | | |
| | | | | (k₀, l₁ + 1), | | | |
| | | | | (k₁, l₁ + 1), | | | |
| | | | | (k₂, l₁ + 1) | | | |
| 14 | 24 | 1, 0.5 | cdm4-FD2- | (k₀, l₀), (k₁, l₀), | 0, 1, 2, 3, 4, 5 | 0, 1 | 0, 1 |
| | | | TD2 | (k₂, l₀), (k₀, l₁), | | | |
| | | | | (k₁, l₁), (k₂, l₁) | | | |
| 15 | 24 | 1, 0.5 | cdm8-FD2- | (k₀, l₀), (k₁, l₀), | 0, 1, 2 | 0, 1 | 0, 1, 2, 3 |
| | | | TD4 | (k₂, l₀) | | | |
| 16 | 32 | 1, 0.5 | fd-CDM2 | (k₀, l₀), (k₁, l₀), | 0, 1, 2, 3, | 0, 1 | 0 |
| | | | | (k₂, l₀), | 4, 5, 6, 7, | | |
| | | | | (k₃, l₀), (k₀, l₀ + 1), | 8, 9, 10, 11, | | |
| | | | | (k₁, l₀ + 1), | 12, 13, 14, 15 | | |
| | | | | (k₂, l₀ + 1), | | | |
| | | | | (k₃, l₀ + 1), | | | |
| | | | | (k₀, l₁), (k₁, l₁), | | | |
| | | | | (k₂, l₁), (k₃, l₁), | | | |
| | | | | (k₀, l₁ + 1), | | | |
| | | | | (k₁, l₁ + 1), | | | |
| | | | | (k₂, l₁ + 1), | | | |
| | | | | (k₃, l₁ + 1) | | | |
| 17 | 32 | 1, 0.5 | cdm4-FD2- | (k₀, l₀), (k₁, l₀), | 0, 1, 2, 3, | 0, 1 | 0, 1 |
| | | | TD2 | (k₂, l₀), (k₃, l₀), | 4, 5, 6, 7 | | |
| | | | | (k₀, l₁), (k₁, l₁), | | | |
| | | | | (k₂, l₁), (k₃, l₁) | | | |
| 18 | 32 | 1, 0.5 | cdm8-FD2- | (k₀, l₀), (k₁, l₀), | 0, 1, 2, 3 | 0, 1 | 0, 1, 2, 3 |
| | | | TD4 | (k₂, l₀), (k₃, l₀) | | | |

The parameters k, l in the table are configured by a high layer signaling.

In an embodiment, the pattern indication may indicate a set of predefined patterns of defining CSI-RS locations within a slot. Each pattern is one row in the above table. For example, the pattern indication may indicate that rows (having the row indexes) 14,15,16,17,18 are not valid. That is the CSI report configurations or CSI-RS resources associated with the indicated rows are not valid.

In an embodiment, the pattern indication indicates a row (index) in the table, to indicate that the pattern in the row having that row index is valid or invalid. In an embodiment, the pattern indication indicates a maximum row index, wherein the pattern in the row of the table having a row index less than or equal to the maximum row index is valid and the pattern in a row having a row index greater than the maximum row index is invalid. In an embodiment, a pattern indication indicates an invalid pattern. In an embodiment, a pattern indication indicates a pattern index, to indicate that the pattern having the indicated pattern index or the row of the pattern having the indicated pattern index is valid or invalid.

In an embodiment, each CSI report configuration is associated with a CSI report configuration ID.

In an embodiment, the Port number indication may indicate a maximum valid port number of the CSI-RS resources associated with a CSI report configuration.

In an embodiment, the Start new CSI calculation indication indicates the UE to re-measure and/or re-calculate the CSI. In other words, the UE does not report the CSI which is generated/determined/measured/calculated according to the CSI-RS resources before receiving the indication (e.g., first signaling).

In an embodiment, the activation/de-activation indication indicates whether a trigger state indication is to trigger/activate the CSI report configuration associate with an indicated trigger state or a trigger state indication is to release/de-active the CSI report configuration associate with an indicated trigger state.

In an embodiment, the activation/de-activation indication activates/de-actives a CSI report configuration.

In some embodiments, the first signaling may indicate at least one or more trigger state indications. In an embodiment, each trigger state includes one or more CSI report configurations and one TCI state. The TCI state indicates a TCI state used for the CSI-RS resources associated with the CSI report configuration.

In some embodiments, the first signaling is/comprises a MAC CE and/or DCI. The

MAC CE may be used to select M trigger state(s) from the trigger state list configured by the high layer signaling (e.g., RRC signaling), where M is an integer value greater than 0 and not greater than a threshold (e.g., 8). The DCI may be used to indicate one trigger state in the trigger states selected by the MAC CE.

In some embodiments, the first signaling is/comprises the DCI.

In an embodiment of the first signaling comprising/being the DCI, the DCI is UE specific DCI (e.g., DCI format 0-1 or DCI format 0-2).

In an embodiment, a field in the DCI is used to indicate at least one of the information (e.g., the abovementioned parameters included in the first signaling).

In an embodiment of the first signaling comprising/being the DCI, a field in the DCI is used to indicate information associated with the trigger state. For example, the field is a CSI request field. In addition, the DCI may be used to trigger an aperiodic CSI report configuration or a semi-persistentOnPUSCH CSI report configuration. The indication in the DCI may also trigger a periodic CSI report configuration or semi-persistent CSI report configuration which is configured to be associated with the aperiodic CSI report configuration or the semi-persistentOnPUSCH CSI report configuration or associated with the trigger state which is trigger state which is triggered.

In an embodiment of the first signaling comprising/being the DCI, the first signaling indicates more than one information (e.g., the abovementioned parameters included in the first signaling) and the information may be indicated in different fields. In this embodiment, some information may be indicated separately in different fields. As an alternative of in addition, some information is indicated together in the same field. For example, a trigger state indication included in the DCI is indicated in one field and a time offset included in the DCI is indicated in another field.

In an embodiment of the first signaling comprising/being the DCI, the DCI triggers a report on PUCCH CSI trigger state, wherein one field of the DCI is used to indicate the trigger state indication and another field of the DCI is used to indicate a time offset. For example, the DCI triggering the report on PUSCH CSI trigger state includes one field configured to indicate a trigger stage indication and another field configured to indicate the time offset.

In an embodiment of the first signaling comprising/being the DCI, if the DCI triggers a trigger state which includes an aperiodic CSI report configuration or a semi-persistentOnPUSCH CSI report configuration, the DCI includes one field to indicate a trigger stage indication and a field to indicate a time offset.

In an embodiment of the first signaling comprising/being the DCI, the first signaling may comprise first DCI and second DCI, where the first DCI may include a field to indicate a trigger state indication and the second DCI may include one field to indicate a trigger stage indication and a field to indicate the time offset.

In an embodiment of the first signaling comprising/being the DCI, the DCI may be a group common DCI. The group common DCI refers to the DCI carrying information for one or more UEs and/or indicates that a field in the DCI is used to indicate information for one or more UEs. Note that, in the present disclosure, the considerations (e.g., designs of the fields, rules, and methods) applied on UE-specific DCI in the present disclosure may also be applied to the group-common DCI.

In an embodiment of the first signaling comprising/being the DCI, the information in the DCI may indicated by a bitmap or a codepoint.

For example, the information may be indicated by the bitmap. The information indicated by the bitmap may be the trigger state activation/de-activation indication. Each bit in the bitmap is corresponding to a trigger state, where the bit ‘0’ means that the corresponding trigger state is de-activated and the bit ‘1’ means that the corresponding trigger state is activated.

For example, the information may be indicated by a codepoint. Each codepoint indicates a trigger state. The trigger state is activated if being indicated by the codepoint in included in the first signaling.

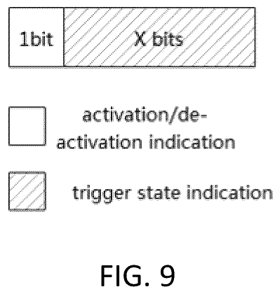

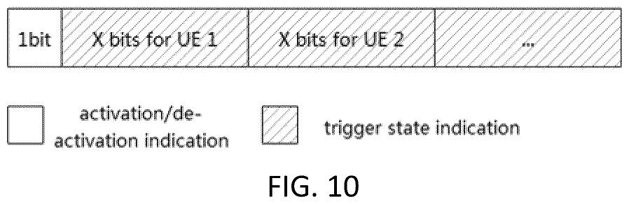

In an embodiment of the first signaling comprising/being the DCI, the fields in the DCI include a bit indicating the activation/de-activation indication and X bit(s) indicating a trigger state indication, where X is a positive integer. For example, the activation/de-activation indication bit is ‘1’ means this DCI (e.g., the X bits) is used for the activation indication, ‘0’ means the X bits is used for deactivation indication. FIG. 9 shows a schematic diagram of the field in the DCI according to an embodiment of the present disclosure. The DCI in FIG. 9 may be UE specific DCI. As shown in FIG. 9, the field in the DCI comprises 1 bit indicating the activation/de-activation indication and X bits indicating a trigger state indication, where X is a positive integer. FIG. 10 shows a schematic diagram of the field in the DCI according to an embodiment of the present disclosure. The DCI in FIG. 10 may be group common DCI. In FIG. 10, the field comprises 1 bit indicating the activation/de-activation indication, X bits of a trigger state indication for UE 1, X bits of a trigger state indication for UE 2, and so on.

In an embodiment of the first signaling comprising/being the group common DCI, the length of trigger state indication field for different UE (e.g., the trigger state indication for UE 1and the trigger state indication for UE 2 in FIG. 10) may be different and/or configured by a high layer signaling.

In an embodiment of the first signaling comprising/being the group common DCI, the field is shared by a group of UEs. In other words, the indications associated with CSI report for a group of UEs are the same.

In an embodiment, a start position of the trigger state indication field for a UE in the DCI is configured by a high layer signaling.

In an embodiment of the first signaling comprising/being the group common DCI, one trigger state indication field may indicate the trigger sate to a group of UEs.

In an embodiment of the first signaling comprising/being the group common DCI, the activation/de-activation indication locates at the beginning of the DCI (e.g., FIG. 10).

In an embodiment, the first signaling is/comprises broadcast DCI and/or multicast DCI. The broadcast or multicast DCI may be scrambled with at least one of the following RNTIs (radio network temporary identifiers): MCCH-RNTI (multicast broadcast service (MBS) control channel RNTI), G-RNTI (group RNTI), or G-CS-RNTI (group configured scheduling RNTI).

In an embodiment of the first signaling comprising/being the DCI, the DCI is scrambled with a specific RNTI. For example, the specific RNTI is used only for the CSI-RS configuration indication. In an embodiment, the CSI-RS configuration indication is the abovementioned parameters included in the first signaling.

In an embodiment of the first signaling comprising/being the DCI, the DCI is scrambled with at least one of the following RNTIs: the MCCH-RNTI, the G-RNTI, or the G-CS-RNTI.

In some embodiment, the first signaling comprises/is the MAC CE.

In an embodiment of the first signaling comprising/being the MAC CE, the MAC CE is scheduled by broadcast/multicast DCI.

In an embodiment of the first signaling comprising/being the MAC CE, the MAC CE includes at least one of the following fields:
the trigger state indication,
an activation/de-activation indication,
a field indicates whether to activate or deactivate indicated trigger state: For example, the field is set to 1 to indicate an activation, otherwise it indicates a deactivation,
a serving cell ID: this field indicates the identity/identifier of the Serving Cell for which the MAC CE applies,
a BWP ID, this field indicates a DL BWP for which the MAC CE applies,
a trigger state list ID, indicating a list of trigger states which shall be activated or deactivated,
a CSI report configuration ID, indicating a CSI report,
a TCI state,
a TCI state list,
a first time offset,
a delta of a power control offset,
a power control offset,
a pattern indication,
a second time offset,
a delta of a port number,
a repetition number,
a port number indication, or
a start new CSI calculate indication.

The definitions of the field comprised in the MAC CE may refer to those with the same name in the DCI.

In an embodiment, the first signaling comprises/is a SIB (system information block).

In an embodiment, the first signaling may be different for different trigger states. For example, the first signaling configured to indicate a report on PUCCH CSI trigger state may be the DCI and the first signaling configured to trigger a report on PUSCH CSI trigger state may be a MAC CE. In an embodiment, the first signaling may be different for different trigger state lists.

In some embodiments, if the UE receives a first signaling indicates a trigger state and the trigger state is associated with at least a periodic CSI report configuration or a semi-persistent CSI report configuration, the UE may perform at least one of:
measurements on a CSI-RS resource configuration which is associated with the periodic CSI report configuration which is triggered by the first signaling,
measurements on a CSI-RS resource configuration associated with the periodic CSI report configuration which is triggered by the first signaling and associated with the lowest CSI report configuration ID (i.e., CSI-ReportConfigId),
measurements on a CSI-RS resource configuration associated with an aperiodic CSI report configuration which is triggered by the first signaling,
measurements on a CSI-RS resource configuration associated with an aperiodic CSI report configuration which is triggered by the first signaling and associated with the lowest CSI report configuration ID (i.e., CSI-ReportConfigId),
measurements on a valid CSI-RS resource configuration associated with a CSI report configuration which is triggered by the first signaling for the first CSI report,
measurements on CSI-RS resource configuration which is the first or most recent valid CSI-RS resource configuration after receiving the first signaling or after an application delay (no matter whether or not the CSI-RS resource is associated with the CSI report configuration or no matter the CSI-RS resource configuration is configured with ‘aperiodic’, ‘semi-persistent’, or ‘periodic’),
measurements on a CSI-RS resource configuration which is activated and associated with the CSI report configuration triggered by the first signaling,
measurements on a CSI-RS resource configuration which is associated with the CSI report configuration triggered by the first signaling (If the CSI-RS resource configuration is not activated before receiving the first signaling, the CSI-RS resource configuration is activated by the first signaling), or
measurements on a CSI-RS resource configuration which is the first or the most recent valid CSI-RS resource configuration after receiving the first signaling or after an application delay, where the CSI-RS resource configuration is the CSI-RS resource configuration which is associated with the CSI report configuration triggered by the first signaling.

In some embodiments, the abovementioned behaviors performed if the UE receives the first signaling indicates a trigger state and the trigger state is associated with at least a periodic CSI report configuration or a semi-persistent CSI report configuration is for the first CSI report after the UE receives the first signaling.

In some embodiments, if the UE receives a first signaling indicates a trigger state and the trigger state is associated with at least a periodic CSI report configuration, the UE behavior may comprise at least one of:
the UE reports the CSI on PUCCH which is configured in a CSI report configuration which is triggered by the first signaling and associated with the lowest CSI report configuration ID (i.e., CSI-ReportConfigId),
the UE reports the CSI on PUCCH which is configured in a CSI report configuration which is triggered by the first signaling,
the UE reports the CSI on a PUSCH, wherein the PUSCH is determined based one a CSI report configuration and the first signaling,
the UE reports the CSI on a PUSCH, if the first signaling indicates a time offset,
the UE reports the CSI on a PUSCH, wherein the PUSCH is associated with an aperiodic or semi-persistentOnPUSCH CSI report configuration with the lowest index,
the UE reports the CSI on a PUCCH or PUSCH which is the first or most recent valid resource after receiving the first signaling or after an application delay or after the most recent valid CSI-RS resource, wherein the PUCCH or PUSCH is associated with the CSI report configuration triggered by the first signaling, or
the UE reports the CSI on a UL resource which is the first or most recent valid resource after receiving the first signaling or after an application delay or after the most recent valid CSI-RS resource, wherein the UL resource is associated with the CSI report configuration triggered by the first signaling.

In some embodiments, the UE measures/receives the CSI-RS after a first application delay (also named first delay) after receiving a first signaling. For example, the first application delay is time duration between the slot or last symbol in which UE receives the first signaling and the first slot/symbol UE measures/receives CSI-RS according to the first signaling. As alternative or in addition, the first application delay is the smallest time duration between the slot or last symbol in which UE receives the first signaling and the first slot/symbol UE measures/receives CSI-RS according to the first signaling.

In some embodiments, the UE reports the CSI after a second application delay (also named second delay) after receiving a first signaling. In some embodiments, the UE transmits the CSI report after a second application delay after receiving a first signaling.

In an embodiment, the second application delay is a time duration between the slot or last symbol in which UE receives the first signaling and the first slot/symbol UE report CSI according to the first signaling.

In an embodiment, the second application delay is the smallest time duration between the slot or last symbol in which UE receives the first signaling and the first slot/symbol UE report CSI according to the first signaling.

In some embodiments, the UE reports the CSI after a third application delay after measuring/receiving the CSI-RS.

In an embodiment, the third application delay (also named third delay) is a time duration between the slot or last symbol of a CSI-RS and the first slot/symbol UE report CSI according to the first signaling.

In an embodiment, the third application delay is the smallest time duration between the slot or last symbol of a CSI-RS and the first slot/symbol UE report CSI according to the first signaling.

In an embodiment, the first application delay/second application delay/third application delay may be associated with (e.g., determined based on) at least one of the following: a predefined value, a high layer signaling, a time domain behavior, UE capability, a SFN (system frame number), an SCS (subcarrier spacing), an ACK (acknowledge), a PUSCH processing time, a CSI computation time, a PDSCH decoding time.

In some embodiments, the first application delay/second application delay/third application delay may be configured by a high layer signaling or predefined.

In some embodiments, the first application delay/second application delay/third application delay may be associated with a time domain behavior. For example, the first application delay/second application delay/third application delay of the CSI report configurations with different time domain behaviors may be different.

In some embodiments, the first application delay/second application delay/third application delay may be associated with an ACK (acknowledge (message)). The UE performs the CSI-RS reception/measurement or reporting the CSI after an ACK by using the first application delay/second application delay/third application delay.

In some embodiments, the first application delay/second application delay/third application delay may be associated with a PUSCH processing time, a CSI computation time, or a PDSCH decoding time. For example, the first application delay/second application delay/third application delay is larger than or equal to the PUSCH processing time, the CSI computation time, or the PDSCH decoding time.

In an embodiment, triggering a trigger state means the CSI report configuration which is associated with the trigger state is triggered or activated or valid.

In an embodiment, a CSI report configuration is triggered or activated or valid means that the UE can report the CSI according to the CSI report configuration.

In an embodiment, a CSI report configuration is de-activated or invalid means that the UE cannot report the CSI according to the CSI report configuration.

In an embodiment, a CSI-RS resource configuration or a CSI-RS resource is de-activated or invalid means that the UE cannot receive/measure based on the CSI-RS according to the CSI-RS resource configuration or CSI-RS resource.

In an embodiment, if a trigger state is not triggered or de-activate or invalid, the UE does not need to report the CSI according to the CSI report configuration (in this trigger state). In an embodiment, if a trigger state is not triggered or de-activated or invalid, the CSI-RS resource configuration which is associated with the CSI report configuration (in the trigger state) cannot be used.

In an embodiment, a CSI-RS resource configuration cannot be used means that the UE does not receive the CSI-RS on the CSI-RS resource (of the CSI-RS resource configuration).

In an embodiment, a CSI-RS resource configuration cannot be used means that the BS (e.g., gNB) does not transmit the CSI-RS on the resources of this CSI-RS resource configuration.

In some embodiments, if a trigger state is triggered and/or if an aperiodic CSI report configuration is triggered, an activation of the CSI report configuration starts after an application delay and ends at the end of the scheduled PUSCH containing the report associated with the aperiodic CSI-RS. If a semi-persistent or periodic CSI report configuration is triggered, an activation of the CSI report configuration starts after an application delay and ends after the semi-persistent CSI report configuration being de-activated by DCI or a MAC CE.

In some embodiments, the aperiodic CSI-RS is associated with the CSI report configuration which is triggered by a first signaling. The aperiodic CSI-RS resource is active after an application delay and ends at the end of the scheduled PUSCH containing the report associated with the aperiodic CSI-RS.

In some embodiments, for the semi-persistent CSI-RS or periodic CSI-RS, the semi-persistent CSI-RS or periodic CSI-RS is active after an application delay and ends at the end of when a deactivation indication is applied.

In some embodiments, if a CSI report configuration is triggered, the CSI-RS resource configuration associated with the CSI report configuration is also triggered. The TCI state of the CSI-RS resource configuration may be determined by or based on at least one of:

-the UE assumes that the TCI state or the QCL (quasi-co location) assumption for the

CSI-RS resource configuration is identical with the first TCI state or QCL assumption which is applied for the CORESET (control resource set) used for the PDCCH (physical downlink control channel) transmission within an active BWP (bandwidth part) of the serving cell,
TCI state indicated by the first signaling,
TCI state associated with a trigger state,
TCI state or QCL assumption which is the same as the first signaling, or
QCL-ed with SSB.

In some embodiments, the UE reports the UE capability to the BS, wherein the UE capacity may at least include/indicate: whether or not support the trigger state list, the number of trigger state lists which is supported, whether or not support the information indicated by first signaling.

In some embodiments, the UE reports UE assistance information to the BS. The UE assistance information may at least include/indicate at least one of: a preferred maximum number of ports, a preferred pattern, or a fallback ask/request. The fallback ask indicates the UE wants to fallback to an original configuration or the UE wants to fallback to a baseline configuration. The baseline configuration may be predefined or configured by a high layer signaling.

In some embodiments, the first signaling indication is enabled if an event occur. In an embodiment, the first signaling indication is enabled means that the gNB can transmit the first signaling to the UE. In an embodiment, the first signaling indication is enabled means the UE monitors the first signaling. In an embodiment, the first signaling indication is enabled means the field exists.

In an embodiment, the event includes at least one of:
receiving an RRC signaling configured to enable the first signaling indication.
receiving an RRC signaling configured to enable the trigger state list, or
a specific trigger state list is configured (the specific trigger state list may be referred to the trigger state list described above).

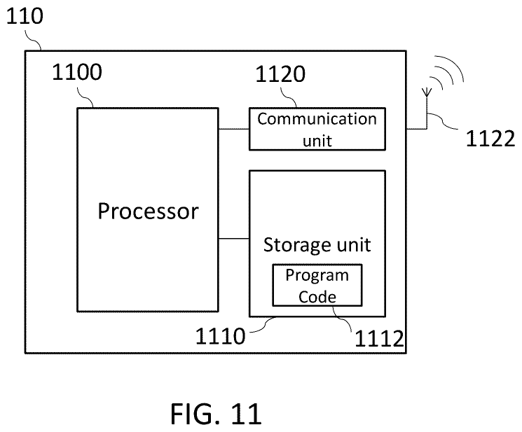

FIG. 11 relates to a schematic diagram of a wireless terminal 110 according to an embodiment of the present disclosure. The wireless terminal 110 may be a user equipment (UE), a mobile phone, a laptop, a tablet computer, an electronic book or a portable computer system and is not limited herein. The wireless terminal 110 may include a processor 1100 such as a microprocessor or Application Specific Integrated Circuit (ASIC), a storage unit 1110 and a communication unit 1120. The storage unit 1110 may be any data storage device that stores a program code 1112, which is accessed and executed by the processor 1100. Embodiments of the storage unit 1110 include but are not limited to a subscriber identity module (SIM), read-only memory (ROM), flash memory, random-access memory (RAM), hard-disk, and optical data storage device. The communication unit 1120 may a transceiver and is used to transmit and receive signals (e.g., messages or packets) according to processing results of the processor 1100. In an embodiment, the communication unit 1120 transmits and receives the signals via at least one antenna 1122 shown in FIG. 11.

In an embodiment, the storage unit 1110 and the program code 1112 may be omitted and the processor 1100 may include a storage unit with stored program code.

The processor 1100 may implement any one of the steps in exemplified embodiments on the wireless terminal 110, e.g., by executing the program code 1112.

The communication unit 1120 may be a transceiver. The communication unit 1120 may as an alternative or in addition be combining a transmitting unit and a receiving unit configured to transmit and to receive, respectively, signals to and from a wireless network node (e.g., a base station).

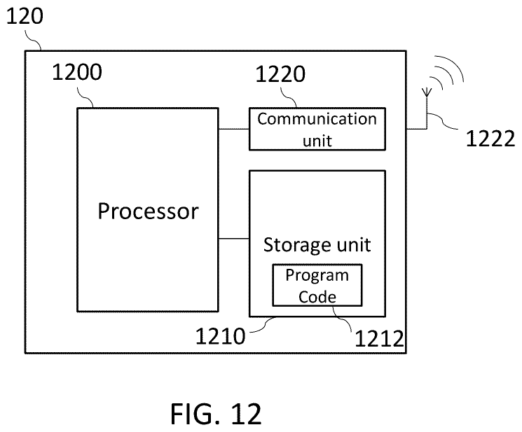

FIG. 12 relates to a schematic diagram of a wireless network node 120 according to an embodiment of the present disclosure. The wireless network node 120 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 120 may comprise (perform) at least one network function such as an access and mobility management function (AMF), a session management function (SMF), a user place function (UPF), a policy control function (PCF), an application function (AF), etc. The wireless network node 120 may include a processor 1200 such as a microprocessor or ASIC, a storage unit 1210 and a communication unit 1220. The storage unit 1210 may be any data storage device that stores a program code 1212, which is accessed and executed by the processor 1200. Examples of the storage unit 1210 include but are not limited to a SIM, ROM, flash memory, RAM, hard-disk, and optical data storage device. The communication unit 1220 may be a transceiver and is used to transmit and receive signals (e.g., messages or packets) according to processing results of the processor 1200. In an example, the communication unit 1220 transmits and receives the signals via at least one antenna 1222 shown in FIG. 12.

In an embodiment, the storage unit 1210 and the program code 1212 may be omitted. The processor 1200 may include a storage unit with stored program code.

The processor 1200 may implement any steps described in exemplified embodiments on the wireless network node 120, e.g., via executing the program code 1212.

The communication unit 1220 may be a transceiver. The communication unit 1220 may as an alternative or in addition be combining a transmitting unit and a receiving unit configured to transmit and to receive, respectively, signals to and from a wireless terminal (e.g., a user equipment or another wireless network node).

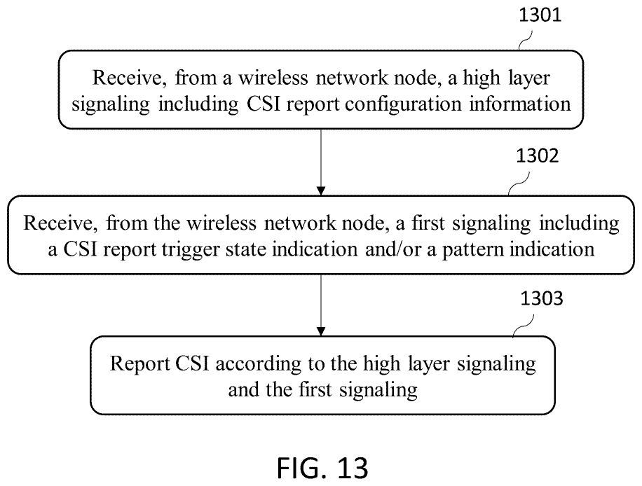

FIG. 13 shows a flowchart of a method according to an embodiment of the present disclosure. The method shown in FIG. 13 may be used in a wireless terminal (e.g., UE) and comprises the following steps:

Step 1301: Receive, from a wireless network node, a high layer signaling including CSI report configuration information.

Step 1302: Receive, from the wireless network node, a first signaling including a CSI report trigger state indication and/or a pattern indication.

Step 1303: Report CSI according to the high layer signaling and the first signaling.

In FIG. 13, the wireless terminal receives a high layer signaling (e.g., RRC signaling) and a first signaling from a wireless network node (e.g., BS). The high layer signaling includes CSI report configuration information and the first signaling includes a CSI report trigger state indication and/or a pattern indication (e.g., for triggering at least one trigger state and/or CSI report configuration in the CSI report configuration information). In some embodiments, the CSI report trigger state indication is the CSI-RS configuration indication. In some embodiments, the

CSI report trigger state indication is the abovementioned parameters included in the first signaling. Based on the high layer signaling and the first signaling, the wireless network report the CSI to the wireless network node. For example, the wireless terminal may perform measurements for the CSI and/or generate the CSI and/or transmit CSI report(s) to the wireless network node.

In an embodiment, the CSI report configuration information comprises at least one of: a CSI report configuration, a CSI-RS resource configuration, or a trigger state list. Note that details of the CSI report configuration, the CSI-RS resource configuration and the trigger state list may be referred to the aforementioned embodiments.

In an embodiment, the first signaling comprises at least one of DCI or a MAC CE. For example, the DCI may be group common DCI, broadcast DCI or multicast DCI.

The details components/parameters comprised in the first signaling (i.e., the DCI and/or MAC CE comprised in the first signaling and the pattern indication) can be referred to above mentioned embodiments.

In an embodiment, the DCI and the MAC CE are used to indicate different trigger states in the CSI report configuration information.

In an embodiment, the CSI is measured no earlier than a first delay after the first signaling is received.

In an embodiment, the CSI is reported no earlier than a second delay after the first signaling is received.

In an embodiment, the CSI is reported no earlier than a third delay after the CSI is measured.

In an embodiment, the wireless terminal reports the CSI according to the high layer signaling and the first signaling by:

triggering a CSI report configuration according to the high layer signaling and the first signaling, and/or

triggering a CSI reference signal resource configuration associated with the triggered CSI report configuration.

In this embodiment, a TCI state of the CSI reference signal resource configuration is the same with a first TCI state applied for a control resource set used for physical downlink control channel within an active bandwidth part of a serving cell. As an alternative, the TCI state of the CSI reference signal resource configuration is indicated by the first signaling. As another alternative, the TCI state of the CSI reference signal resource configuration is associated with a trigger state. As still another alternative, the TCI state of the CSI reference signal resource configuration is the same with a TCI state of the first signaling. As other alternative, the TCI state of the CSI reference signal resource configuration and an SSB has a QCL relationship.

In an embodiment, the wireless terminal transmits assistance information comprising a maximum number of ports to the wireless network node.

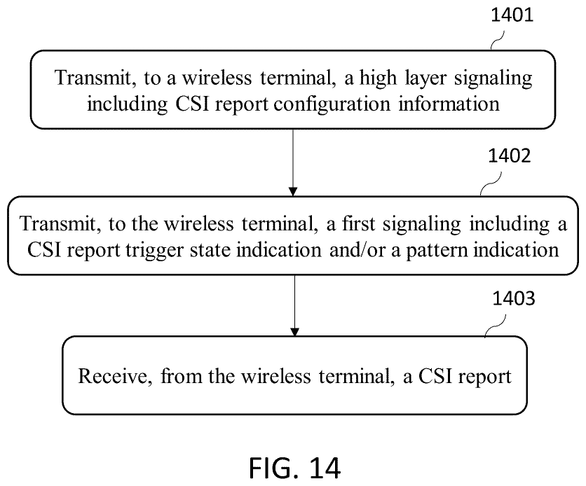

FIG. 14 shows a flowchart of a method according to an embodiment of the present disclosure. The method shown in FIG. 14 may be used in a wireless network node (e.g., BS or gNB) and comprises the following steps:

Step 1401: Transmit, to a wireless terminal, a high layer signaling including CSI report configuration information.

Step 1402: Transmit, to the wireless terminal, a first signaling including a CSI report trigger state indication and/or a pattern indication.

Step 1403: Receive, from the wireless terminal, a CSI report.

In this embodiment, the wireless network node transmits a high layer signaling including CSI report configuration information to the wireless terminal (e.g., UE). The wireless network node further transmits a first signaling including a CSI report trigger state indication and/or a pattern indication to the wireless terminal, e.g., to trigger at least one trigger state and/or CSI report configuration in the CSI report configuration information. The wireless network node therefore can receive a CSI report and may accordingly optimize/adjust communication parameters for communicating with the wireless terminal.

In an embodiment, the CSI report configuration information comprises at least one of: a CSI report configuration, a CSI-RS resource configuration, or a trigger state list. Note that details of the CSI report configuration, the CSI-RS resource configuration and the trigger state list may be referred to the aforementioned embodiments.

In an embodiment, the first signaling comprises at least one of DCI or a MAC CE. For example, the DCI may be group common DCI, broadcast DCI or multicast DCI.

The details components/parameters comprised in the first signaling (i.e., the DCI and/or MAC CE and/or the pattern indication comprised in the first signaling) can be referred to above mentioned embodiments.

In an embodiment, the DCI and the MAC CE are used to indicate different trigger states in the CSI report configuration information.

In an embodiment, the wireless network node receives assistance information comprising a maximum number of ports from the wireless terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method for use in a wireless terminal, the wireless communication method comprising:
receiving, from a wireless network node, a high layer signaling including channel state information (CSI) report configuration information,
receiving, from the wireless network node, a first signaling including a CSI report trigger state indication or a pattern indication, and
reporting CSI according to the high layer signaling and the first signaling.

2. The wireless communication method of claim 1, wherein the CSI report configuration information comprises at least one of:
a CSI report configuration,
a CSI-RS resource configuration, or
a trigger state list.

3. The wireless communication method of claim 2, wherein each trigger state in the trigger state list is associated with at least one of:
a delta of a power control offset, or
a power control offset.

4. The wireless communication method of claim 3, wherein the power control offset used for CSI report is determined by the power control offset configured in an associated CSI-RS resource configuration and the delta of power control offset, wherein the power control offset configured in an associated CSI-RS resource configuration is PowerControlOffset configured in NZP-CSI-RS-Resource signaling.

5. The wireless communication method of claim 3, wherein the power control offset used for CSI report is equal to subtracting the delta of the power control offset from PowerControlOffset configured in NZP-CSI-RS-Resource signaling.

6. The wireless communication method of claim 2, wherein the trigger state list comprises trigger states associated with CSI report configurations and time domain behaviors of the CSI report configurations associated with the trigger state list comprise a plurality of time domain behaviors.

7. The wireless communication method of claim 2, wherein each trigger state in the trigger state list is associated with a plurality of CSI report configurations having the same or different time domain behaviors.

8. The wireless communication method of claim 6, wherein the time domain behavior associated with each trigger state comprise at least one of periodic, aperiodic, semi-persistent, semi-persistent on physical uplink control channel (PUCCH), or semi-persistent on physical uplink shared channel (PUSCH).

9. The wireless communication method of claim 2, wherein each trigger state in the trigger state list is associated with at least one periodic CSI report configuration.

10. The wireless communication method of claim 1, wherein a periodic CSI report configuration in the CSI report configuration information is associated with at least one of: an aperiodic CSI report configuration, a trigger state which is in an aperiodic trigger state list, a trigger state which is in a semi-persistent trigger state list, or a semi-persistent CSI report configuration.

11. The wireless communication method of claim 1, wherein a semi-persistent CSI report configuration in the CSI report configuration information is associated with an aperiodic CSI report configuration or a trigger state which is in an aperiodic trigger state list.

12. The wireless communication method of claim 1, wherein a periodic CSI report configuration or a semi-persistent CSI report configuration is triggered if at least one of the following events occurs:
an aperiodic CSI report configuration associated with the periodic CSI report configuration or the semi-persistent CSI report configuration is triggered,
a trigger state associated with the periodic CSI report configuration or the semi-persistent CSI report configuration is triggered, or
a semi-persistent CSI report configuration associated with the periodic CSI report configuration or the semi-persistent CSI report configuration is triggered.

13. The wireless communication method of claim 1, wherein at least part of CSI reference signal resources included in a CSI resource configuration is valid if a CSI report configuration which is in the CSI report configuration information and is associated with the CSI resource configuration is triggered to be valid.

14. The wireless communication method of claim 1, wherein the first signaling comprises at least one of downlink control information (DCI), or a media access control (MAC) control element (CE).

15. The wireless communication method of claim 1, wherein at least one of the following applies:
the CSI is measured or a CSI reference signal is received no earlier than a first delay after the first signaling is received,
the CSI is reported no earlier than a second delay after the first signaling is received, or
the CSI is reported no earlier than a third delay after the CSI is measured or a CSI reference signal is received.

16. The wireless communication method of claim 1, wherein the reporting the CSI according to the high layer signaling and the first signaling comprises:
triggering a CSI report configuration according to the high layer signaling and the first signaling, and
triggering a CSI reference signal resource configuration associated with the triggered CSI report configuration,
wherein:
a TCI state of the CSI reference signal resource configuration is the same with a first TCI state applied for a control resource set used for physical downlink control channel within an active bandwidth part of a serving cell,
a TCI state of the CSI reference signal resource configuration is indicated by the first signaling,
a TCI state of the CSI reference signal resource configuration is associated with a trigger state,
a TCI state of the CSI reference signal resource configuration is the same with a TCI state of the first signaling, or
a TCI state of the CSI reference signal resource configuration and a Synchronization Signal Block, SSB has a quasi-co-location relationship.

17. The wireless communication method of claim 1, further comprising:
transmitting, to the wireless network node, assistance information comprising at least one of a maximum number of ports, a preferred pattern or a fallback ask.

18. A wireless terminal comprising at least one processor configured to:
receive, from a wireless network node, a high layer signaling including channel state information (CSI) report configuration information, and
receive, from the wireless network node, a first signaling including a CSI report trigger state indication or a pattern indication, and
report CSI according to the high layer signaling and the first signaling.

19. The wireless terminal of claim 18, wherein:
each trigger state in the trigger state list is associated with at least one of:
a delta of a power control offset, or
a power control offset; and
the power control offset used for CSI report is determined by the power control offset configured in an associated CSI-RS resource configuration and the delta of power control offset, wherein the power control offset configured in an associated CSI-RS resource configuration is PowerControlOffset configured in NZP-CSI-RS-Resource signaling.

20. The wireless terminal of claim 18, wherein a periodic CSI report configuration or a semi-persistent CSI report configuration is triggered if at least one of the following events occurs:
an aperiodic CSI report configuration associated with the periodic CSI report configuration or the semi-persistent CSI report configuration is triggered,
a trigger state associated with the periodic CSI report configuration or the semi-persistent CSI report configuration is triggered, or
a semi-persistent CSI report configuration associated with the periodic CSI report configuration or the semi-persistent CSI report configuration is triggered.
